(19) United States
(12) Patent Application Publication
(10) Pub. No.: US 2010/0241537 A1
(43) Pub. Date: Sep. 23, 2010

(54) DEBT SALES SYSTEM AND METHOD

(75) Inventors: Stephen B. Kass, Bel Air, CA (US); Michael E. Bernstein, Palm Beach, FL (US); Kevin Davis, Delray Beach, FL (US)

Correspondence Address: ROTHWELL, FIGG, ERNST & MANBECK, P.C., 1425 K STREET, N.W., SUITE 800, WASHINGTON, DC, 20005, US

(73) Assignee: CreditMax LLC, West Palm Beach, FL (US)

(21) Appl. No.: 12/791,516

(22) Filed: Jun. 1, 2010

Related U.S. Application Data
(63) Continuation of application No. 11/506,208, filed on Aug. 18, 2006, now abandoned.
(60) Provisional application No. 60/709,099, filed on Aug. 18, 2005.

(51) Int. Cl. G06Q 40/00; G06Q 10/00; G06Q 50/00; G06Q 20/00; G06F 17/30

(52) U.S. Cl. 705/30; 705/36 R; 705/37; 707/770; 707/E17.014

(57) ABSTRACT

A system and method for transferring credit accounts over a network include steps and means for receiving search criteria from a user, searching a credit account database for available credit accounts based on the search criteria, providing results of the searching to the user, the results including a summary of available credit accounts and a purchase price for each available credit account, receiving a selection of at least one of the available credit accounts from the user, calculating a total purchase price for the selected at least one of the available credit accounts, receiving a purchase request from the user corresponding to the selected at least one of the available credit accounts, providing an invoice to the user for the total purchase price, receiving a payment from the user in response to the invoice; and in response to the received payment, removing the selected credit accounts from the credit account database.

### CROSS-REFERENCE TO RELATED APPLICATIONS

This application claims priority to provisional application No. 60/709,099, filed on Aug. 18, 2005, the entire contents of which are incorporated herein by reference.

### BACKGROUND OF THE INVENTION

1. Field of the Invention

The present invention relates generally to Internet commerce, and more particularly, to a method for selling credit accounts over a network. According to the present invention, purchase and sale transactions can be consummated and reported in real-time to provide the credit industry accurate up to date pricing information for all credit accounts individually or in systematically grouped packages of credit accounts.

2. Description of the Related Art

Debt of all types including performing, sub-performing, and non-performing commercial and consumer, including but not limited to, credit cards, loans, mortgage loans, home equity loans, medical debt, healthcare, bankruptcies, unpaid telecom, utility bills, education, student loans, government, retail, insurance, and cable debt (collectively referred to herein as “Credit Accounts”) has been mounting. Credit providers are faced with the occurrence of significant expense resulting from increasing delinquencies, charge-offs and bankruptcies, oftentimes forcing credit providers to sell Credit Accounts to various companies in the debt-buying industry, such as, for example, Portfolio Recovery Associates, Asset Acceptance Capital Corp., Encore Capital Group, NCO Group and Asta Funding Inc. As a result of the historical increase in volume of Credit Accounts there has been a corresponding increase in purchase and sales of Credit Accounts. This increase in volume has further resulted in a need for a more efficient manner, of purchasing, selling, and trading Credit Accounts.

Historically, the debt buying industry has been highly fragmented, consisting of many small and relatively undercapitalized “mom and pop” type collection agencies and/or debt owners. Today, at a time when debt is selling at, or near, historical high prices, Debt collection companies are having a difficult time collecting at a profitable level due to: (I) reduced agency fees that the debt owner charges the agency as a means of reducing expense in collecting the debt purchased at today's higher prices; (ii) the high cost of collections primarily caused from an extremely high (30-40%) turnover rate in the collection industry; (iii) the increasing collection costs associated with Federal and State regulations that require agencies to strictly monitor collection efforts/tactics; (iv) Consumer advocacy groups taking a more active role; (v) the increased expense associated with litigation and claim settlement from the litigious environment that this industry operates within: and, (vi) the increased need for skip tracing efforts to locate the debtor In a more transient society. In turn, many debt owners must now rely more heavily on a back end sales strategy in lieu of merely collecting the Credit Accounts for a pre-determined period of time in order to recover their investment let alone make a profit.

There has been an increase in money available to purchase debt in the debt market today, from capital raised by public companies as well as private direct investment by Wall Street firms. Easy access to capital has not only made debt acquisition funding readily available but also has created a corresponding demand to deploy these funds. Large debt issuers (creators) have recognized the rapid build up of available acquisition funding (some have even participated in the offering of this acquisition financing) and have believed that the “top” of the market was not yet reached and thus reduced the supply of debt being offered thereby exacerbating the inverted supply/demand curve resulting in a steep price increase making it more difficult for debt owners to perform at or above break even. Because the debt collection agencies rely on contingent fee collectors to manage the collection effort, if the collection agency does not purchase new accounts each month for the contingent fee collectors to work, the collectors must leave the agency and find work at an agency that is still purchasing debt each month.

Recently, many public companies in the debt industry have seen a significant reduction in market value due to reduced earnings from either: (i) purchasing debt at increased prices to preserve their collection network or; (ii) not purchasing debt (at inflated values that leave little or no opportunity for profit) the volumes needed to satisfy their internal collection infrastructure. Many of these large debt owners either collect all or part of the debt for a period of time and/or sell part of the debt to a re-sale market. Recently, with inflated market prices, debt owners have either relied more heavily on a sales strategy as a “bail out” strategy from their initial inflated purchase price or have extended their collection cycle holding onto the debt longer hoping that collections will increase over historical levels. Often such a strategy, extended collection cycle, is merely a means of postponing the inevitable recognition of loss resulting from paying more for an asset that its inherent value, i.e., “asset impairment” This extended collection cycle strategy continues for one, two, three levels down from the initial sale from the Credit Provider.

At each stage the market value must remain above the intrinsic value of the debt account in order for the seller to re-coup his initial investment. At a certain stage of the debt cycle, the disparity between the market and intrinsic value of the asset prohibits the seller from finding a “bail out” buyer to purchase the asset resulting in the holder of the asset then realizing of a loss. This loss recognition will continue upstream to impact the earlier stage buyers who will be forced to recognize that if they pay too much for the asset the back end sale will not occur at a price that will “bail out” the debt account owner. This reversal of debt account pricing dynamics will result in debt accounts selling at reduced prices. Concurrent with the market dynamics reducing demand for debt accounts, the large debt account issuers (creators) will sense the pending reduced pricing and begin to sell greater volumes of debt accounts in an effort to increase sales while higher values may still remain. This will actually exacerbate the rate at which the price reduction occurs. In essence the buyer at each stage of the debt cycle needs for the intrinsic value of the asset to equal or exceed the market price for the asset if the industry is to enjoy price stability.

Credit providers to date have sold on a bulk large package of individual debt accounts) basis due to not having the infrastructure to sell on a piecemeal basis. This method of selling accounts provides a trade off of greater volume for less value. The reduced value is because when buying bulk, purchasers must buy certain debt accounts that they do not want due to geographic, account balance, debtor characteristics, or any other reason. These Credit Providers have historically sold to large national buyers and not to the small local buyer who potentially have the ability to pay the highest price for those accounts that meet the buyers' criteria and specific collection experience and skills. Instead the large national buyer, in turn, may sell on a more regional basis to either regional or state buyers. When the large national buyer then resells to these smaller more regionalized buyers the national buyer is able to mark-up the price of the debt to the price reflecting the value of the debt to the buyer in whose hands the debt is worth the most. Many of the debt buyers that have overpaid for the debt more recently rely on a debt resale strategy similar to this.

At some point, however, the eventual owner of the debt can no longer sell the debt at an inflated price to recoup his investment because the buyer that collects the debt obligation who has no resale opportunity can no longer survive at the prices that the debt is being offered. In turn, that buyer tells the seller that he no longer wants the debt at such an inflated price. That seller that is attempting to sell the debt can no longer purchase the debt at that price since he no longer can rely on a sales strategy at a mark-up as a “bail out” for his over paying for the debt account. Localized buyers have not been afforded the opportunity to purchase the type of debt that they would ideally prefer to buy. These buyers cannot purchase directly from the credit provider due to their size, funding availability or for licensing issues. The credit provider is losing all of the mark-up that the secondary buyers of the debt are receiving when they sell the debt downstream to more regional, state, or local buyers. As large as the debt market has become, there is no truly efficient marketplace for debt to be traded.

Thus, there is a need for new and improved systems and methods for selling, trading and exchanging debt.

### SUMMARY OF THE INVENTION

Embodiments of the present invention provide a method for selling, trading, and exchanging Credit Accounts on an individual account or pooled basis and their future contracts for delivery on a specified future date over a network.

According to embodiments of the present invention, a system and method for transferring credit accounts over a network include steps and means for receiving search criteria from a user, searching a credit account database for available credit accounts based on the search criteria, providing results of the searching to the user, the results including a summary of available credit accounts and a purchase price for each available credit account, receiving a selection of at least one of the available credit accounts from the user, calculating a total purchase price for the selected at least one of the available credit accounts, receiving a purchase request from the user corresponding to the selected at least one of the available credit accounts, providing an invoice to the user for the total purchase price, receiving a payment from the user in response to the invoice; and in response to the received payment, removing the selected credit accounts from the credit account database.

According to embodiments of the present invention, a system provides maximum flexibility to both debt buyers and debt sellers. Debt buyers never had the ability to purchase the exact accounts that they desire. AS a result of the present invention, buyers can now purchase the specific types or characteristics of debt without being burdened with less desirous accounts.

According to embodiments of the present invention, debt sellers can sell via the present invention those accounts that they feel have greater market value than economic value relative to that seller. For example, a debt owner that may not collect well on New York debt with average balances between $5,000 and $10,000 may determine that the market price for those accounts may be higher than the economic value in terms of attempting to collect that debt.

According to embodiments of the present invention, a system may also provide debt owners the ability to sell put options to debt buyers. The put gives the debt owner the right but not the obligation to sell future debt at a specified price within a specified time. A put becomes more valuable as the price of the underlying debt depreciates relative to the strike price. If the market price for debt increases in the future and is greater than the strike price, the seller will elect not to exercise the put, but rather sell the debt at the higher market price. A debt owner may want to sell a put option for a specified date in the future to hedge for market conditions. In that event, the debt owner knows up-front how much collections are needed on that portfolio.

According to embodiments of the present invention, buyers of debt can receive a call option which gives the debt buyer the right but not the obligation to purchase future debt at a specified price within a specified time. The owner of the call option will exercise the right to purchase the debt at the strike price if the strike price is less than the market price of the underlying debt. For example, if the strike price for the debt is 7.00% and the market price for the underlying debt becomes 8.00%, the owner of the call option would exercise the right to purchase at the strike price and conversely, if the market price for the underlying debt becomes 6.00%, the owner of the call option would not exercise the right to purchase at the strike price because the owner of the right could purchase the underlying debt for a lower price.

According to embodiments of the present invention, buyers and sellers of debt can enter into forward flow agreements that allow for the sale and purchase of debt to occur at a specified price for a specified amount of time. For example, a seller and buyer may enter into a three month forward flow agreement for the purchase and sale of a specified monthly amount of debt at a pre-determined price. Forward flow agreements provide the buyer with a steady flow of debt which is beneficial when placing the accounts with collection agencies/collectors as opposed to a one-off purchase which can impact the continuous flow of debt. For this reason, buyers typically pay a premium price to enter into a forward flow agreement.

According to embodiments of the present invention, a system may provide buyers and sellers of debt with a real time exchange. Despite the vast size of the debt industry, there is no true market indicator of price. The Debt Sales System will provide the trade data in order to create an efficient market. Buyers and sellers will now know what specific debt is worth or its trade value.

According to other embodiments, a buyer or group of buyers is in direct contact via electronic or telephone with a seller or group of sellers for “live” bidding on debt or debt portfolio.

According to other embodiments, the present invention provides a site/market where options on future debt may be acquired/sold. Any type of financial instruments like “puts”, “calls” “options” and “asset exchange” can be used to allow a debt owner of one type of debt offers to buy or sell his debt for another debt of a different type. For example, one debt owner could exchange 100 million dollars of 180 day old credit card debt for 30 million dollars of performing consumer loans.

### BRIEF DESCRIPTION OF THE DRAWINGS

The above and other advantages of this invention will become more apparent by the following description of invention and the accompanying drawings.

FIG. 1 depicts a system block diagram in accordance with an embodiment of the present invention.

FIG. 2 presents a flowchart illustrating a method for selling credit accounts over a network in accordance with an embodiment of the present invention.

FIG. 3 presents an overview chart in accordance with an embodiment of the present invention.

FIG. 4 presents a search process flowchart in accordance with an embodiment of the present invention.

FIG. 5 presents a purchase process flowchart in accordance with an embodiment of the present invention.

FIG. 6 presents a data flow chart in accordance with an embodiment of the present invention.

FIG. 7 presents a pricing process flowchart in accordance with an embodiment of the present invention.

FIGS. 8-16 illustrate display interfaces in accordance with embodiments of the present invention.

### DETAILED DESCRIPTION OF THE PREFERRED EMBODIMENTS

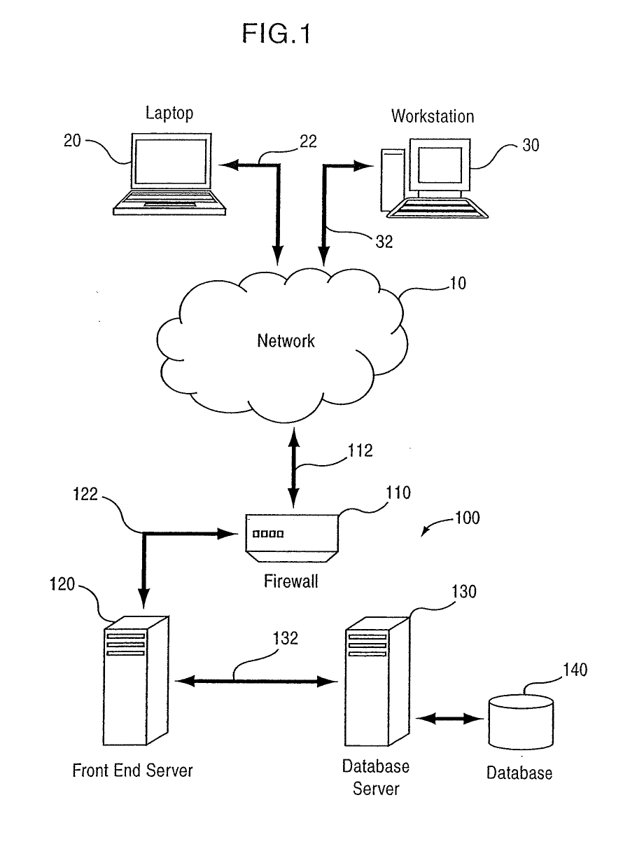

FIG. 1 depicts an exemplary system architecture diagram in accordance with an embodiment of the present invention.

Laptop 20 and workstation 30 are personal computers (PC) connected to network 10 through networks 22 and 32, respectively. Networks 22 and 32 may be wired or wireless networks, private or public networks, local or wide area networks, virtual networks, etc., or any combination thereof. Network 10 is, generally, a wide area public network, such as, for example, the Internet. Typically, laptop 20 and workstation 30 access the Internet through respective Internet Service Providers (ISPs) (not shown). Other embodiments of network 10 include wired or wireless networks, private or public networks, local or wide area networks, virtual networks, etc.

Front end server 120 is connected to network 10 directly (not shown) or through firewall 110, and to database server 130 through network 132. Front end server 120 and database server 130 may be custom-built servers, industry standard servers, such as, for example, HP ProLiant servers, etc. Front end server 120 executes software implementing various features of the present invention, while database server 130 generally manages credit account database 140. For example, Microsoft's .NET, Windows Server and SQL Server software packages may be deployed on these machines. In an alternative embodiment, front end server 120 also functions as database server 130, i.e., a single server may be employed.

Embodiments of networks 112, 122 and 132 include wired or wireless networks, local or wide area networks, virtual networks, etc., or any combination thereof. Network 112 is a public network, connecting firewall 110 to network 10, while networks 122 and 132 are private networks. While database server 130 is depicted as being connected to front end server 120 via network 132, networks 122 and 132 may also be a single network. Accordingly, one embodiment of the present invention includes a single server connected directly to the Internet.

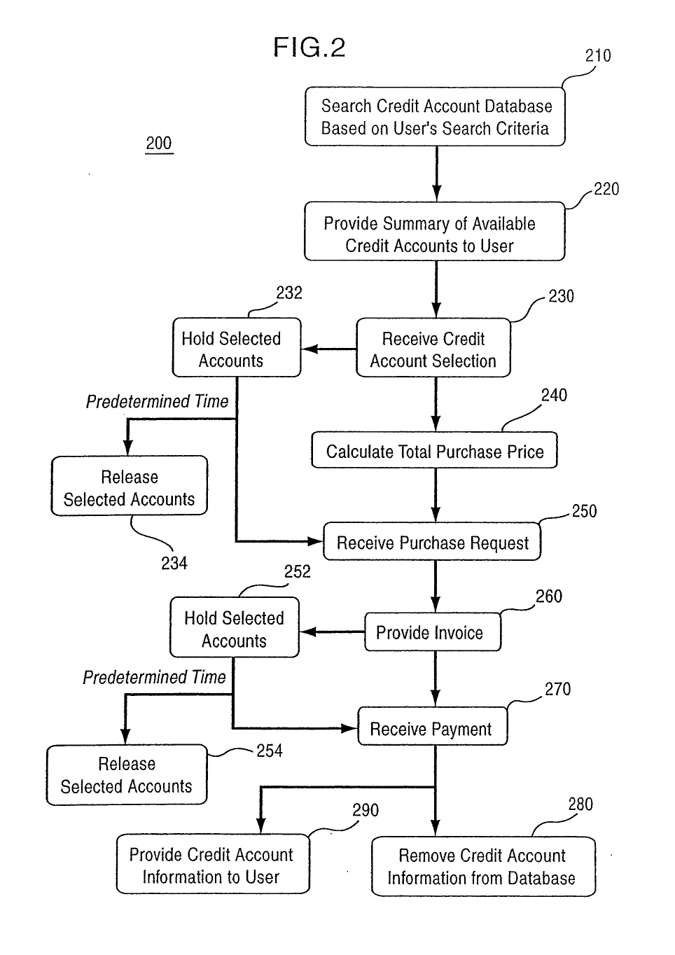

FIG. 2 is a flowchart illustrating a method for selling credit accounts over a network in accordance with an embodiment of the present invention.

In an embodiment, method 200 includes searching (step 210) a credit account database for available credit accounts based on search criteria received from a user; providing (step 220) a summary of available credit accounts to the user, including a purchase price for each available credit account; receiving (step 230) a selection of available credit accounts from the user; calculating (step 240) a total purchase price for the selected credit accounts; receiving (step 250) a purchase request from the user; providing (step 260) an invoice to the user; receiving (step 270) a payment from the user; and removing (step 280) the selected credit accounts from the credit account database.

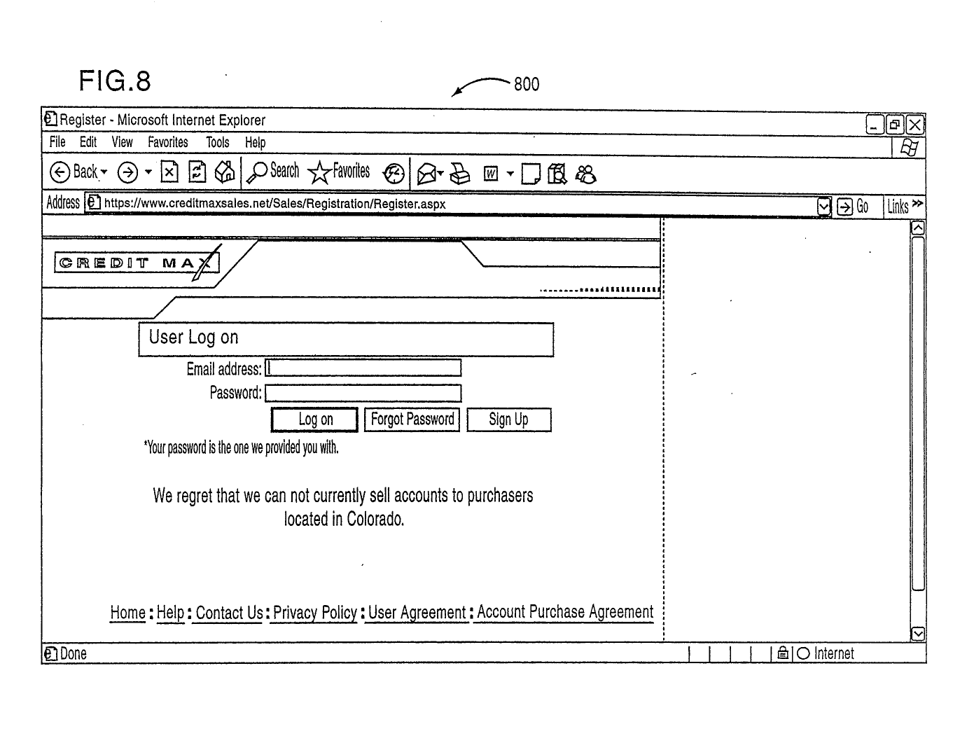

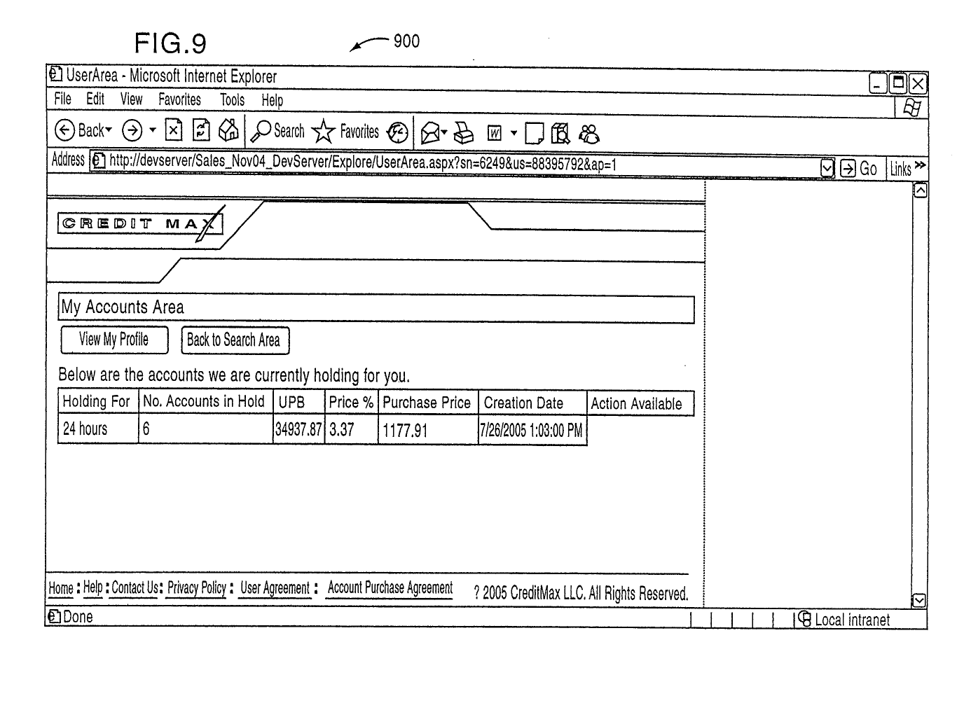

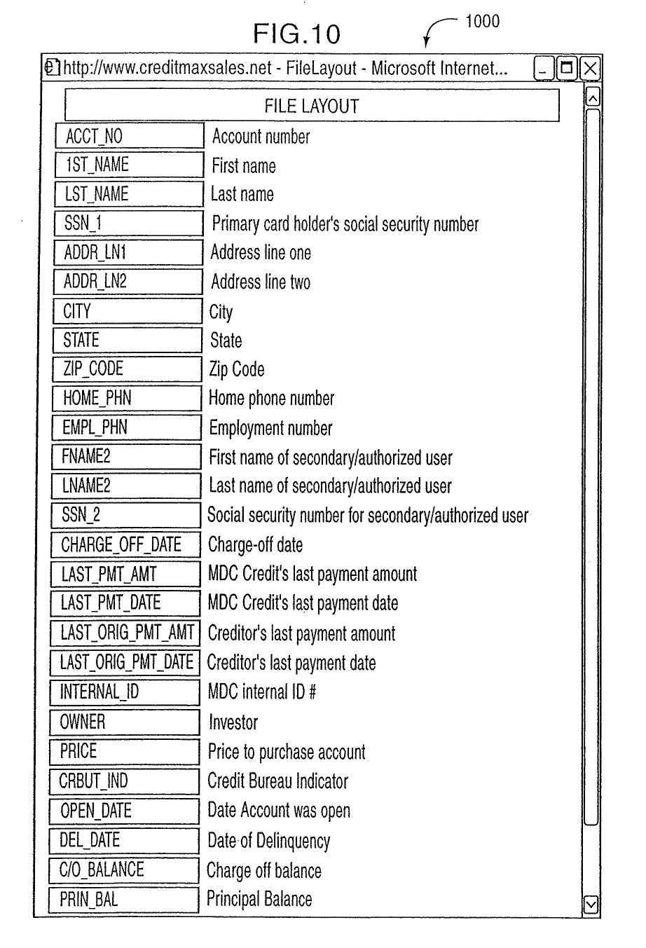

A user initially logs into front end server 120 from laptop 20, workstation 30, etc. A user login screen 800 is shown in FIG. 8. The data connection between the user's computer and front end server 120 may be encrypted using any one of a number of well-known methods for encrypting data transmitted between network computers, such as, for example, HTTPS, etc. If desired, a summary of the user's accounts may be displayed. An exemplary user account summary display 900 is shown in FIG. 9. The layout of a typical credit account file, within database 840, may also be displayed to the user, as shown, for example, in the credit account file layout 1000 in FIG. 10.

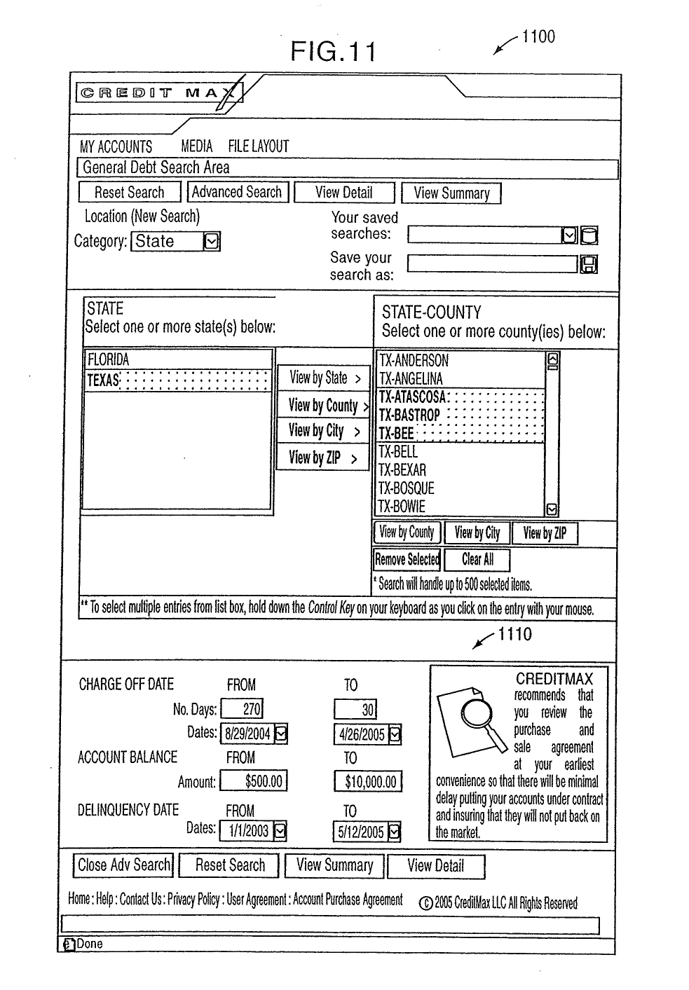

To begin searching (Step 210) for available credit accounts, various search criteria are entered by the user, including, for example, a state, a county, a city, a zip code, a charge-off date, an account balance, a delinquency date, etc. Exemplary search areas 1100 and 1110 are shown in FIG. 11. Using the search criteria specified by the user, front end server 120 sends a search request to database server 130 over network 132. Database server 130 queries credit account database 140 based on the search request, and sends a reply to front end server 120 that includes a list of available credit accounts.

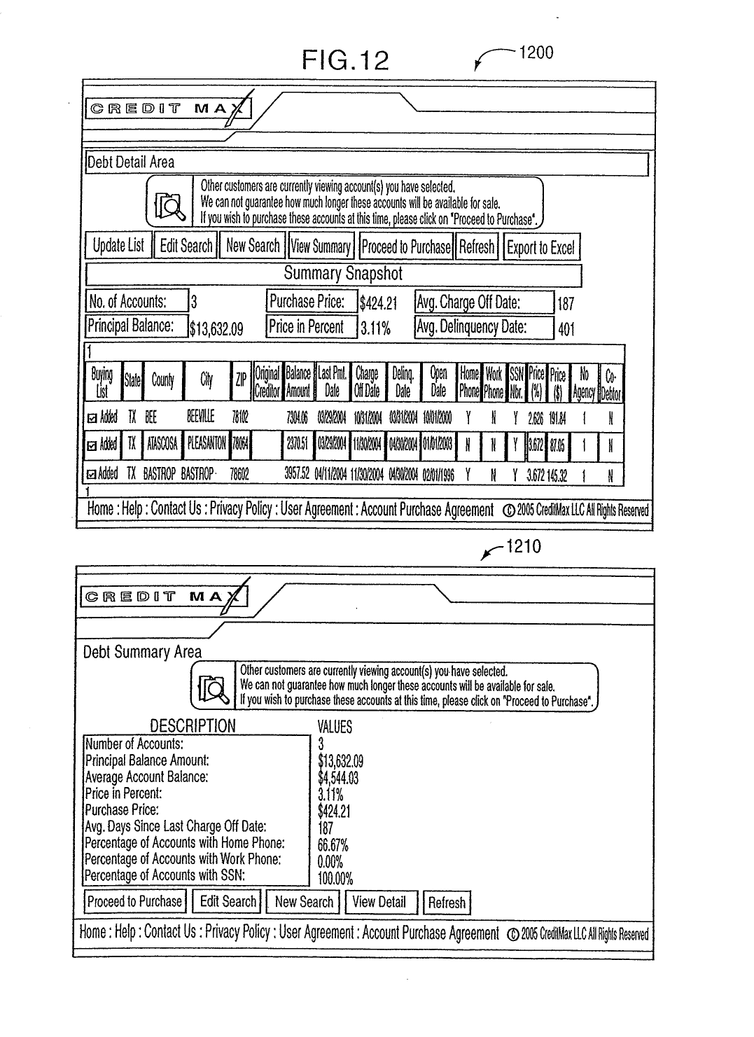

Front end server 120 then provides (Step 220) a summary of available credit accounts to the user, including a purchase price for each available credit account. An exemplary summary is shown in FIG. 12. Debt detail area 1200 can include the state, county, city and zip code where the debt is located, the identity of the original creditor, the balance amount, the last payment date, the charge off date, the delinquency date, the open date, whether the account includes a home or work phone number, a social security number, the price percentage, the price amount, the number of agencies involved and whether there is a co-debtor.

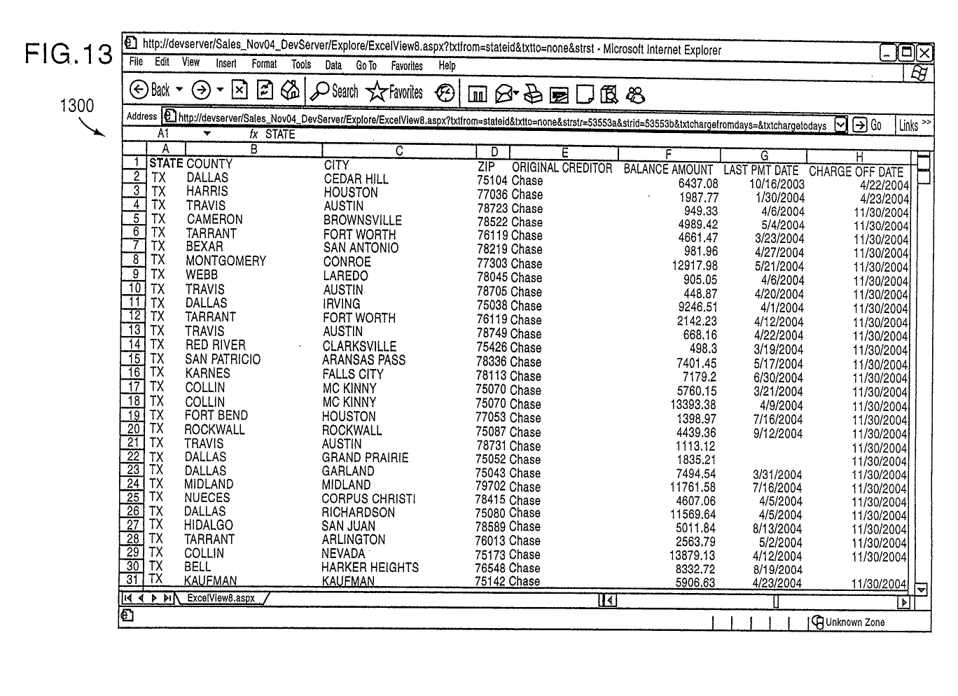

Front end server 120 then receives (Step 230) the selection of available credit accounts from the user and calculates (Step 240) a total purchase price for the selected credit accounts. A summary of the selected credit accounts may be displayed to the user, including the total purchase price. For example, debt summary area 1210 includes the number of accounts, principle balance amount, average account balance, price as a percentage, purchase price, average days since last charge off date, percentage of accounts with phone numbers or social security numbers. The available credit accounts may also be exported to Excel and viewed by the user, as shown in FIG. 13. As shown, the summary 1300 is in a grid format.

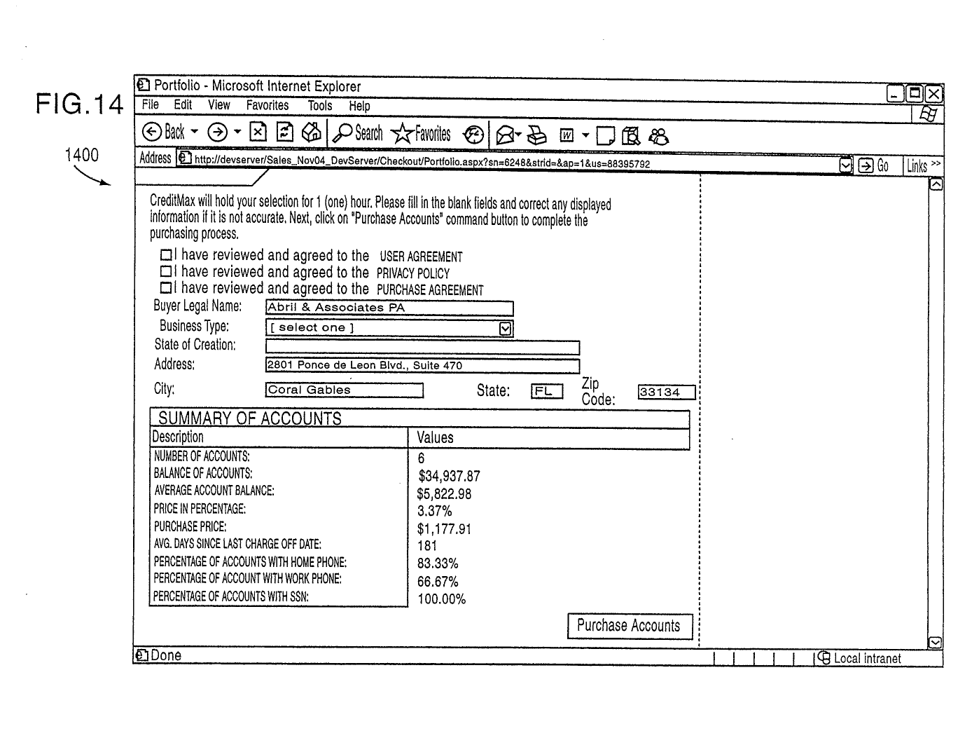

Once selected, the user then purchases the credit accounts. Front end server 120 receives (step 250) the purchase request from the user. The received purchase request may also include an acknowledgement of, a review of and an agreement to a purchase agreement, a user agreement and a privacy policy. For example, FIG. 14 shows summary screen with a purchase account area 1400, which includes the same information as shown in FIG. 12.

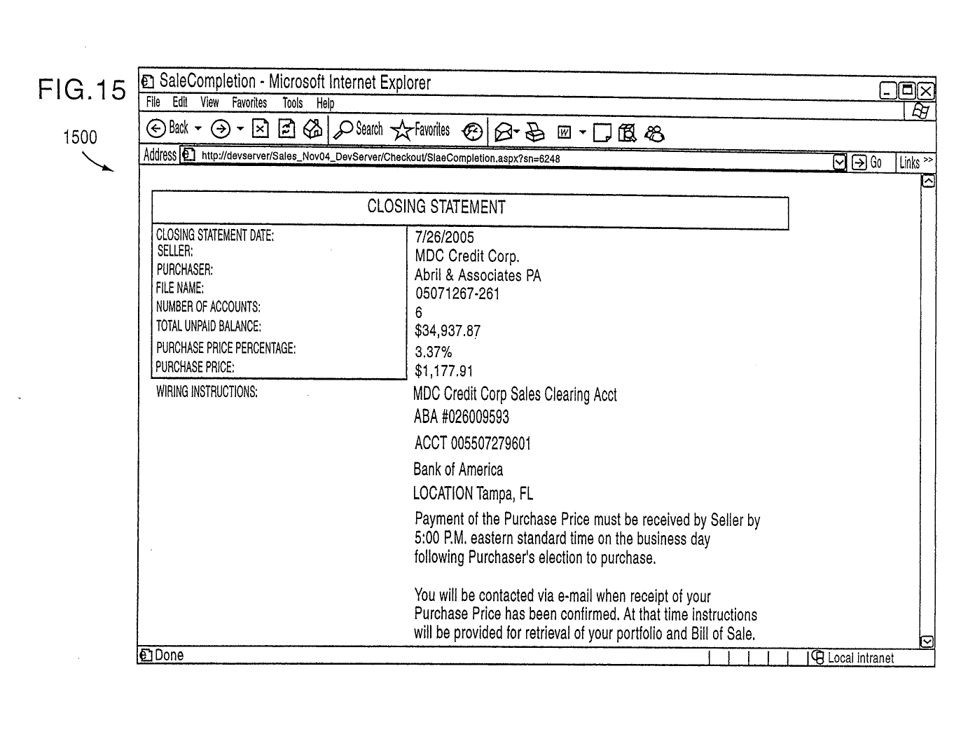

In response to receiving (step 250) the purchase request, front end server provides (step 260) an invoice to the user. An exemplary closing statement 1500 shown in FIG. 15. After payment is received (step 270) from the user, the purchased credit accounts are removed (step 280) from database 140. For example, front end server 120 may send a request to database server 130 to remove the purchased credit accounts from database 140.

The process 200 may also include, after receiving (step 230) the selection, holding (step 232) the selected credit accounts for a predetermined time period, such as, for example, 1 hour, and if the purchase request is not received (250) within the predetermined time period, releasing (step 234) the selected credit accounts.

Process 200 may additionally include steps of, after receiving (step 250) the purchase request, holding (step 252) the selected credit accounts for another predetermined time period, such as, for example, 24 hours; and if the payment is not received (step 270) within the predetermined time period, releasing. (step 254) the selected credit accounts. In an embodiment, holding (steps 232, 252) the selected accounts includes marking the appropriate records within credit account database 140 as “unavailable” for new searches, while releasing (steps 234, 254) the selected accounts includes marking the appropriate records within credit account database 140 as “available” for new searches. Mechanisms for locking database records are well-known in the art and may be adapted for use herein.

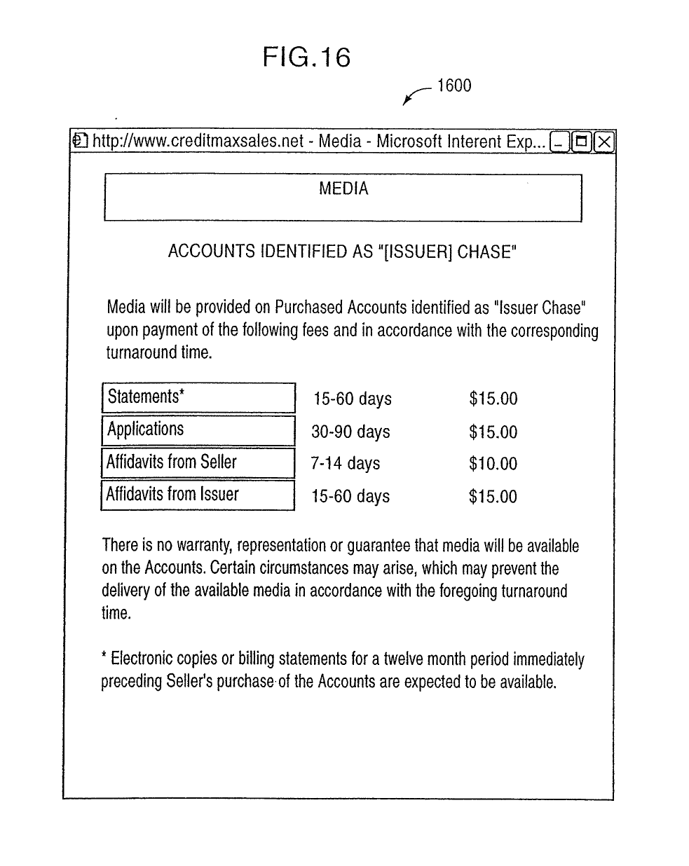

After receiving (step 270) the payment from the user, information associated with the purchased credit accounts may be provided (step 290) to the user. This information may include, for example, a debtor name, a debtor address, an original creditor, a balance amount, a last payment date, a charge off date, a delinquency date, an open date, a home phone number, a work phone number, a social security phone number and co-debtor information. In one embodiment, media is provided from the original credit accountholder. See, e.g., purchased account media information 1600 (FIG. 16).

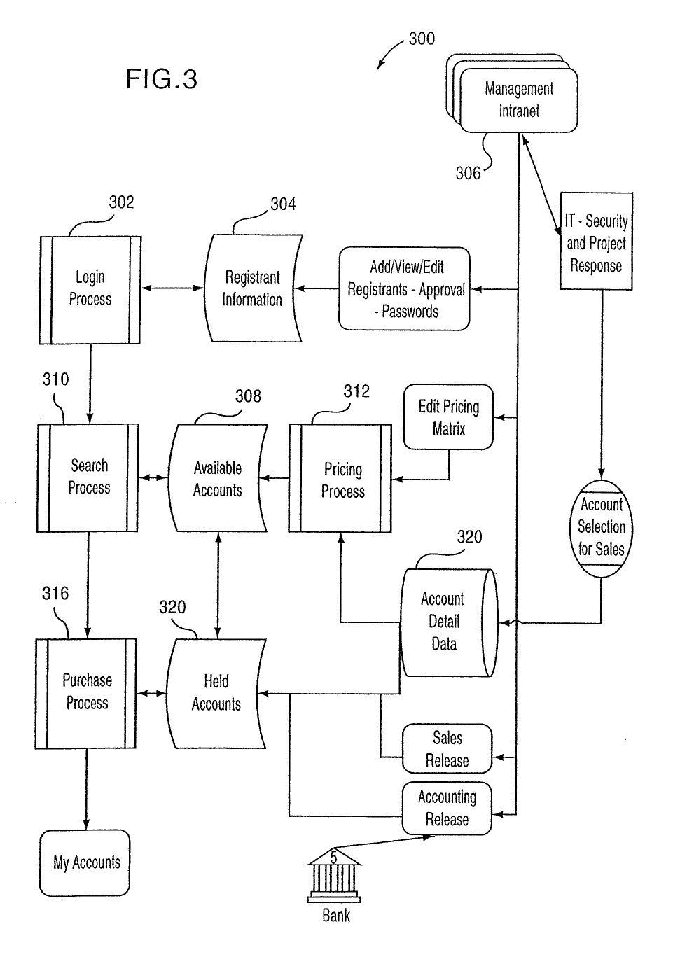

FIG. 3 is an overview data process diagram 300 illustrating an exemplary data processing arrangement in DSS. A login process 302 uses registrant data 304, which can be maintained by via management intranet 306. Available account information 308 can be accessed by a search process 310, a pricing process 312 and is connected to held accounts information 314. A purchase process 316 accesses the held accounts data 314. The pricing process 312 also receives account detail data 320.

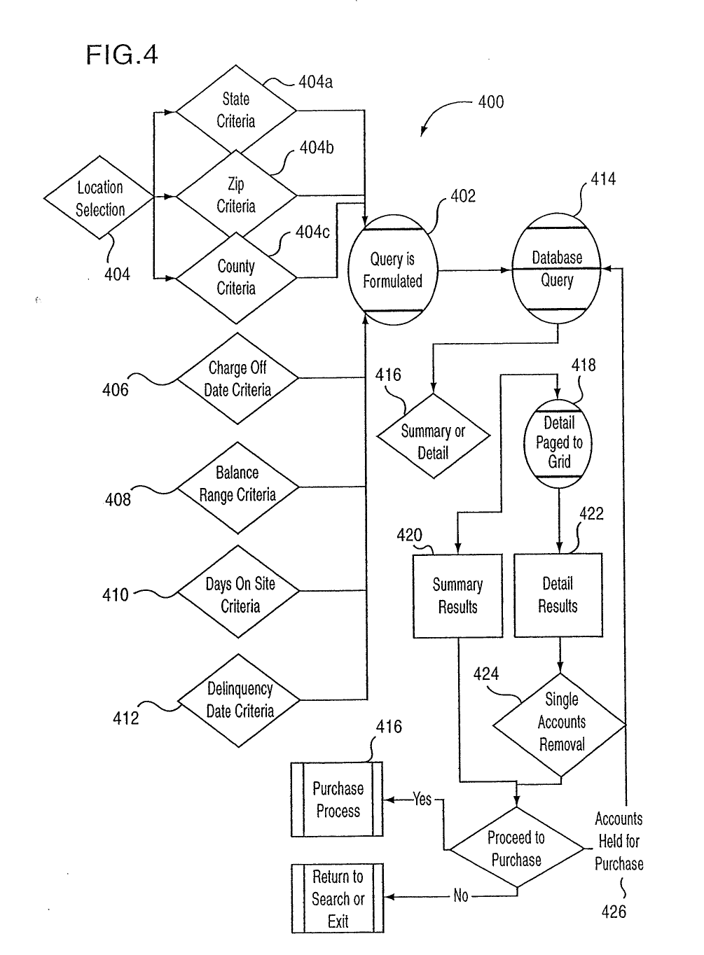

FIG. 4 is a flow chart of an exemplary search process (210). As shown, a query 402 can be formulated from a number of criteria 1004-1012. The query is executed against the database 414 and the results can be in summary and drilled down to any level of detail 416-424. Accounts can be held for purchase 426, which would feed into the purchase process 416.

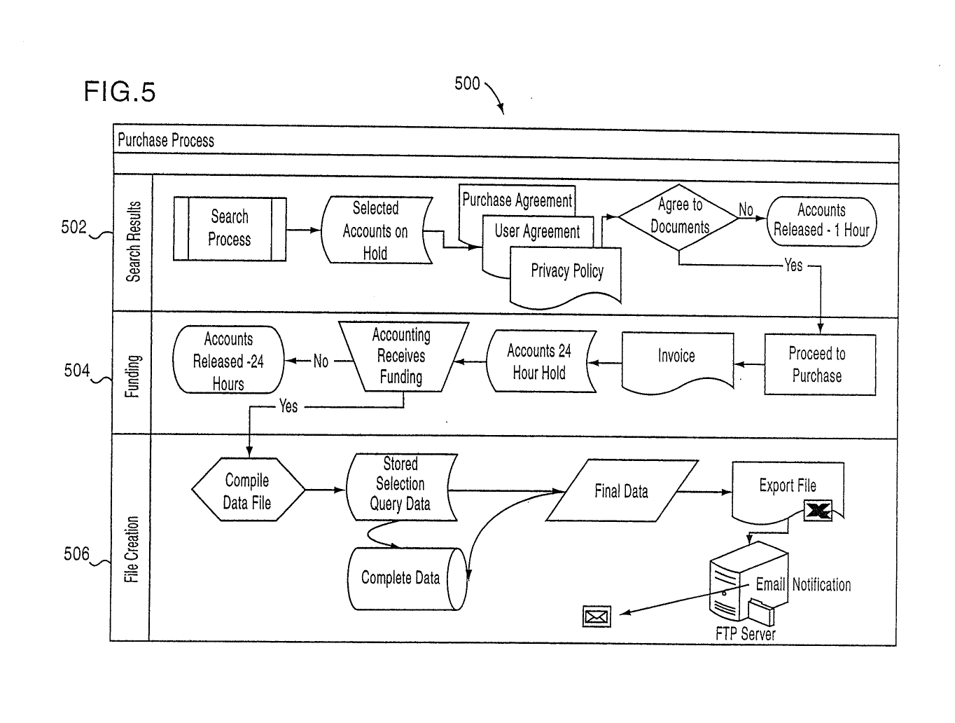

FIG. 5 illustrates an exemplary purchase process flow. The purchase process includes three sub-processes: search results 502, funding 504, and file creation 506. The search results sub-process 502 includes steps for going through various purchase agreements, user agreement, and privacy policies for held accounts. After a period of time, held accounts can be released.

In the funding sub-process 504 invoices are processed and the process is moved to the file creation sub-process for the paid accounts. None paid accounts can be released after a predetermined mount of time.

In the file creation sub-process 506, a file is created and exported based on the purchase. The file preferably contains all the data associated with the purchased account(s). Files can be sent by email, FTP or other known means.

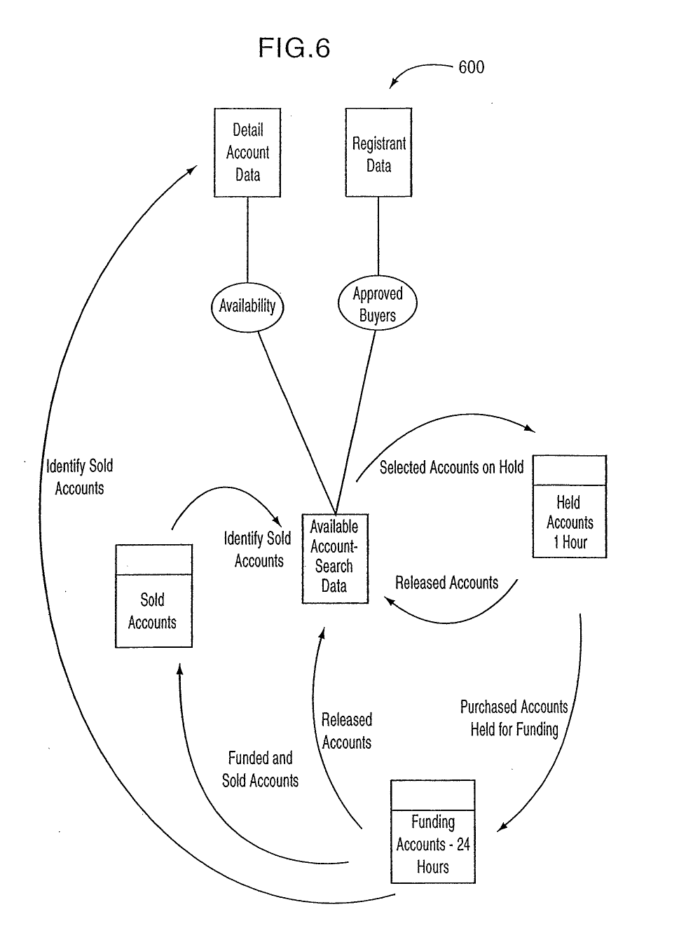

FIG. 6 is a data flow chart overview showing account data during the purchase process.

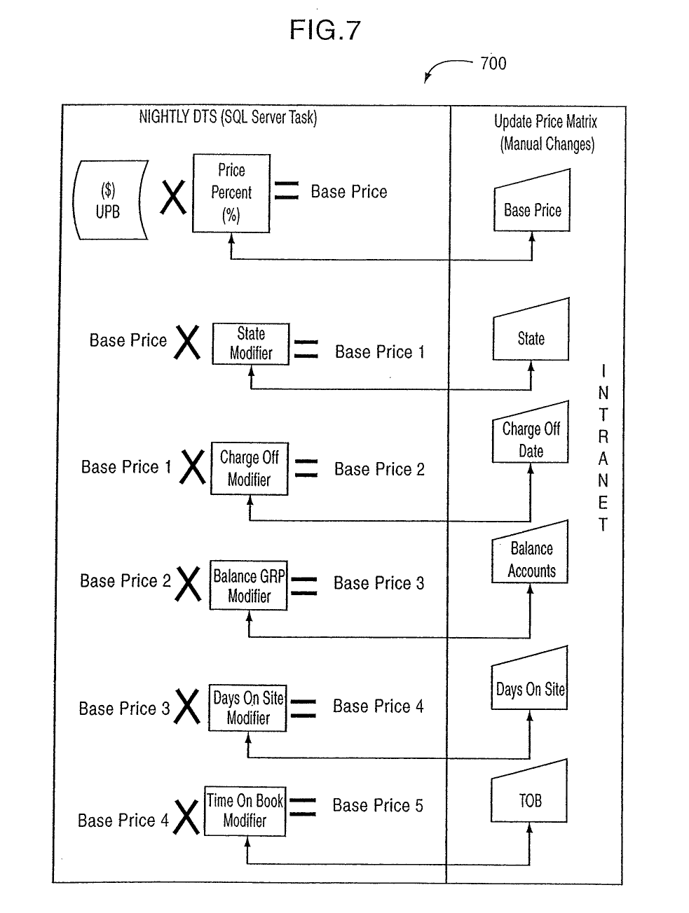

FIG. 7 illustrates a pricing process that can be run on a periodic basis, such as nightly, in accordance with embodiments of the present invention. The purchase price for each credit account within credit account database 140 may be calculated by applying a series of price modifiers to a baseline price. In the embodiments depicted within FIGS. 2 and 7, a price matrix may include several price modifiers, which may be updated by an operator of the debt sale system. The price matrix may include, for example, a base price percent modifier, a state modifier, a days-since-charge-off modifier, a balance size modifier, a days-on-site modifier and a time-on-book modifier. These modifiers may be cumulatively applied to the baseline price to arrive at purchase price, as depicted within FIG. 7. Intermediate base prices 1-5 are also depicted within FIG. 7. Other modifiers may also be used, including, for example, a county modifier, a city modifier, a zip code modifier, days-since-last-payment modifier, a product type modifier, an asset modifier, a mortgage modifier, a FICO score modifier, a marital status modifier, an income modifier, a debtor status modifier and a credit history modifier. In one embodiment, database server 130 updates the purchase price of each credit account within credit account database 140 periodically using the modifiers within the price matrix.

As noted above, FIGS. 8-16 are screen shots of display interface screens in accordance with embodiments of the present invention. FIG. 8 illustrates an exemplary user login screen 800. FIG. 9 illustrates an exemplary user account summary screen 900. FIG. 10 illustrates an exemplary credit account file layout 1000. FIG. 11 illustrates an exemplary search screen 1100 and 1110. FIG. 12 illustrates an exemplary debt summary and detail screen 1200 and 1210. FIG. 13 illustrates an exemplary account detail view 1300. FIG. 14 illustrates an exemplary purchase account summary screen 1400. FIG. 15 illustrates an exemplary invoice or closing statements 1500. FIG. 16 illustrates an exemplary purchased account media information screen 1600. The display fields on each of the screen are self evident.

While this invention has been described in conjunction with specific embodiments thereof, many alternatives, modifications and variations will be apparent to those skilled in the art. Accordingly, the preferred embodiments of the invention as set forth herein, are intended to be illustrative, not limiting. Various changes may be made without departing from the true spirit and full scope of the invention as set forth herein.

1-61. (canceled)

62. A computer implemented method for transferring credit accounts over a network, each credit account being associated with one or more debtors, comprising steps of:
maintaining a credit account database of credit accounts available for immediate purchase;
receiving search criteria from a user;
searching said credit account database for available credit accounts based on said search criteria;
providing results of said searching to the user, said results including a summary of available credit accounts and a purchase price for each available credit account;
receiving a selection of at least one of said available credit accounts from the user;
calculating a total purchase price for the selected at least one of said available credit accounts based on characteristics of the one or more debtors associated with the selected at least one of said available credit accounts;
receiving a purchase request from the user corresponding to said selected at least one of said available credit accounts;
providing an invoice to the user for said total purchase price;
receiving a payment from the user in response to said invoice; and
in response to the received payment, removing the selected credit accounts from the credit account database.

63. The method as recited in claim 62, further comprising steps of:
transferring said selected at least one of said available credit accounts to the user.

64. The method as recited in claim 62, wherein said payment comprises one or more credit accounts to be exchanged for said selected at least one of said available credit accounts.

65. The method as recited in claim 62, wherein said available credit accounts comprise performing, sub performing and non-performing credit accounts;

66. The method as recited in claim 62, wherein said available credit accounts comprise any combination of credit accounts for healthcare, credit card, consumer loans, auto deficiencies, commercial, home equity, mortgage, telecommunications, education, government, financial, utilities, retail, insurance, cable, and technologies.

67. The method as recited in claim 62, wherein said criteria comprises account characteristics including at least one of open date, delinquency date, charge off date, last payment date, balance amount, last payment amount, number of agencies the account has been previously placed with for collections, performing, sub-performing, non-performing, and debt types.

68. The method as recited in claim 67, wherein said debt type includes at least one of healthcare, credit card, consumer loans, auto deficiencies, commercial, home equity, mortgage, telecommunications, education, government, financial, utilities, retail, insurance, cable, and technologies.

69. The method as recited in claim 62 wherein said criteria comprises at least one of country, region, state, county, city and zip code.

70. The method as recited in claim 62 wherein said criteria comprises at least one of an availability of home or work phone numbers, assets, fico scores, marital status and income.

71. The method as recited in claim 62, further comprising steps of:
after receiving said selection, holding said selected at least one available credit account for a first predetermined time period; and
if the purchase request is not received within the first predetermined time period, releasing said selected at least one available credit account.

72. The method as recited in claim 71, further comprising steps of:
after receiving said purchase request, holding said selected at least one available credit account for a second predetermined time period; and
if the payment is not received within the second predetermined time period, releasing said selected at least one available credit account.

73. The method as recited in claim 71, wherein said holding step includes marking said selected at least one available credit account as unavailable, and said releasing step includes marking said selected at least one available credit account as available.

74. The method as recited in claim 73, wherein said holding steps each include marking said selected at least one available credit account as unavailable, and said releasing steps each include marking said selected at least one available credit account as available.

75. The method as recited in claim 62, wherein said step of calculating includes calculating a purchase price for each of the available credit accounts of the selected at least one of said available credit accounts and wherein the characteristics of the associated debtor used in the calculating include zip code of the residence of the debtor, and wherein the purchase price is further adjusted by multiplying by one or more of the following modifiers:
a base price percent modifier, a state modifier, a days-since-charge-off modifier, a balance size modifier, a days-on-site modifier and a time-on-book modifier.

76. The method as recited in claim 75, wherein said step of calculating the purchase price is further adjusted by multiplying by at least one of the following modifiers:
a county modifier, a city modifier, days-since-last-payment modifier, a product type modifier, an asset modifier, a mortgage modifier, a FICO score modifier, a marital status modifier, an income modifier, a debtor status modifier and a credit history modifier.

77. The method as recited in claim 75, wherein each modifier is cumulatively applied to the calculated purchase price.

78. The method as recited in claim 75, wherein said the purchase price for each of the credit accounts is calculated periodically.

79. The method as recited in claim 62, further comprising as step of after receiving the payment, marking the purchased credit accounts as unavailable before removing the purchased credit accounts from the credit account database.

80. The method as recited in claim 62, further comprising a step of after receiving the payment, providing information associated with the purchased credit accounts to the user.

81. The method as recited in claim 80, wherein said information associated with the purchased credit accounts includes a debtor name, a debtor address, an original creditor, a balance amount, a last payment date, a charge off date, a delinquency date, an open date, a home phone number, a work phone number, a social security phone number and co-debtor information.

82. The method as recited in claim 62, wherein said purchase request includes an acknowledgment of and agreement to a purchase agreement, a user agreement and a privacy policy.

83. A system for selling credit accounts over a network, each credit account being associated with one or more debtors, said system comprising:
a credit account database for storing and maintaining information relating to credit accounts available for immediate purchase; and
a server device coupled with said credit account database and to the network, said server adapted to receive a search request from a user over the network, to search said credit account database for available credit accounts based on said search request, to provide results of said search to the user over the network, said results including a summary of available credit accounts and a purchase price for each available credit account, to receive a selection of at least one of said available credit accounts from the user, to calculate a total purchase price for the selected at least one of said available credit accounts based on characteristics of the one or more debtors associated with the selected at least one of said available credit accounts, to receive a purchase request from the user corresponding to said selected at least one of said available credit accounts, to provide an invoice to the user for said total purchase price, to receive indication that a payment has been made by the user in response to said invoice; and in response to the payment indication, to removed the selected credit accounts from the credit account database.

84. The system as recited in claim 83, wherein the server device also hosts the database.

85. The system as recited in claim 83, wherein the server device is coupled to the network through a firewall.

86. The system as recited in claim 83, wherein said server device is further adapted to transfer said selected at least one of said available credit accounts to the user.

87. The system as recited in claim 83, wherein said payment comprises one or more credit accounts to be exchanged for said selected at least one of said available credit accounts.

88. The system as recited in claim 83, wherein said available credit accounts comprise performing, sub performing and non-performing credit accounts;

89. The system as recited in claim 83, wherein said available credit accounts comprise any combination of credit accounts for healthcare, credit card, consumer loans, auto deficiencies, commercial, home equity, mortgage, telecommunications, education, government, financial, utilities, retail, insurance, cable, and technologies.

90. The system as recited in claim 83, wherein said criteria comprises account characteristics including at least one of open date, delinquency date, charge off date, last payment date, balance amount, last payment amount, number of agencies the account has been previously placed with for collections, performing, sub-performing, non-performing, and debt types.

91. The method as recited in claim 90, wherein said debt type includes at least one of healthcare, credit card, consumer loans, auto deficiencies, commercial, home equity, mortgage, telecommunications, education, government, financial, utilities, retail, insurance, cable, and technologies.

92. The system as recited in claim 83 wherein said criteria comprises at least one of country, region, state, county, city and zip code.

93. The system as recited in claim 83 wherein said criteria comprises at least one of an availability of home or work phone numbers, assets, fico scores, marital status and income.

94. The system as recited in claim 83, wherein said server device is further adapted to:
after receiving said selection, to hold said selected at least one available credit account for a first predetermined time period; and
if the purchase request is not received within the first predetermined time period, to release said selected at least one available credit account.

95. The system as recited in claim 94, wherein said server device is further adapted to:
after receiving said purchase request, to hold said selected at least one available credit account for a second predetermined time period; and
if the payment is not received within the second predetermined time period, to release said selected at least one available credit account.

96. The system as recited in claim 94, wherein the holding includes marking said selected at least one available credit account as unavailable, and the releasing includes marking said selected at least one available credit account as available.

97. The system as recited in claim 95, wherein when an account is held, the server device marks said selected at least one available credit account as unavailable in the database, and when an account is released, the server device marks said selected at least one available credit account as available.

98. The system as recited in claim 83, wherein said server device is further adapted to calculate a purchase price for each of the available credit accounts of the selected at least one of said available credit accounts and wherein the characteristics of the associated debtor used in the calculating include zip code of the residence of the debtor, and wherein the purchase price is further adjusted by multiplying by one or more of the following modifiers:
a base price percent modifier, a state modifier, a days-since-charge-off modifier, a balance size modifier, a days-on-site modifier and a time-on-book modifier.

99. The system as recited in claim 98, wherein calculating the purchase price is further adjusted by multiplying by at least one of the following modifiers:
a county modifier, a city modifier, days-since-last-payment modifier, a product type modifier, an asset modifier, a mortgage modifier, a FICO score modifier, a marital status modifier, an income modifier, a debtor status modifier and a credit history modifier.

100. The system as recited in claim 98, wherein each modifier is cumulatively applied to the calculated purchase price.

101. The system as recited in claim 98, wherein said the purchase price for each of the credit accounts is calculated periodically.

102. The system as recited in claim 83, wherein after receiving the payment, the server makes the purchased credit accounts as unavailable before removing the purchased credit accounts from the credit account database.

103. The system as recited in claim 83, after receiving the payment, the server provides information associated with the purchased credit accounts to the user.

104. The system as recited in claim 103, wherein said information associated with the purchased credit accounts includes a debtor name, a debtor address, an original creditor, a balance amount, a last payment date, a charge off date, a delinquency date, an open date, a home phone number, a work phone number, a social security phone number and co-debtor information.

105. The system as recited in claim 83, wherein said purchase request includes an acknowledgment of and agreement to a, purchase agreement, a user agreement and a privacy policy.

106. A system for selling credit accounts over a network, each credit account being associated with one or more debtors, said system comprising:
means for storing and maintaining information relating to credit accounts available for immediate purchase;
means for receiving search criteria from a user;
means for searching the information relating to available credit accounts for available credit accounts that match said search criteria;
means for providing results of said searching to the user, said results including a summary of available credit accounts and a purchase price for each available credit account;
means for receiving a selection of at least one of said available credit accounts from the user;
means for calculating a total purchase price for the selected at least one of said available credit accounts based on characteristics of the one or more debtors associated with the selected at least one of said available credit accounts;
means for receiving a purchase request from the user corresponding to said selected at least one of said available credit accounts;
means for providing an invoice to the user for said total purchase price;
means for receiving a payment from the user in response to said invoice; and
means for making the selected credit accounts unavailable in response to the received payment.

107. The system as recited in claim 106, further comprising means for transferring said selected at least one of said available credit accounts to the user.

108. The system as recited in claim 106, further comprising means for accepting one or more credit accounts to be exchanged for said selected at least one of said available credit accounts.

109. The system as recited in claim 106, wherein said available credit accounts comprise any combination of credit accounts for healthcare, credit card, consumer loans, auto deficiencies, commercial, home equity, mortgage, telecommunications, education, government, financial, utilities, retail, insurance, cable, and technologies.

110. The system as recited in claim 106, wherein said criteria comprises account characteristics including at least one of open date, delinquency date, charge off date, last payment date, balance amount, last payment amount, number of agencies the account has been previously placed with for collections, performing, sub-performing, non-performing, and debt types.

111. The method as recited in claim 110, wherein said debt type includes at least one of healthcare, credit card, consumer loans, auto deficiencies, commercial, home equity, mortgage, telecommunications, education, government, financial, utilities, retail, insurance, cable, and technologies.

112. The system as recited in claim 106 wherein said criteria comprises at least one of country, region, state, county, city and zip code.

113. The system as recited in claim 106 wherein said criteria comprises at least one of an availability of home or work phone numbers, assets, fico scores, marital status and income.

114. The system as recited in claim 106, further comprising means for holding said selected at least one available credit account for a first predetermined time period and if the purchase request is not received within the first predetermined time period, releasing said selected at least one available credit account.

115. The system as recited in claim 114, further comprising means for, after receiving said purchase request, holding said selected at least one available credit account for a second predetermined time period and, if the payment is not received within the second predetermined time period, releasing said selected at least one available credit account.

116. The system as recited in claim 106, wherein said means for calculating a purchase price calculates a purchase price for each of the available credit accounts of the selected at least one of said available credit accounts and wherein the characteristics of the associated debtor used in the calculating include zip code of the residence of the debtor, and wherein the purchase price is further adjusted by multiplying by one or more of the following modifiers:
a base price percent modifier, a state modifier, a days-since-charge-off modifier, a balance size modifier, a days-on-site modifier and a time-on-book modifier.

117. The system as recited in claim 116, wherein said means for calculating a purchase price calculates the purchase price is further adjusted by multiplying by at least one of the following modifiers:
a county modifier, a city modifier, a county modifier, a city modifier, a zip code modifier, days-since-last-payment modifier, a product type modifier, an asset modifier, a mortgage modifier, a FICO score modifier, a marital status modifier, an income modifier, a debtor status modifier and a credit history modifier.

118. The system as recited in claim 116, wherein each modifier is cumulatively applied to the calculated purchase price.

119. The system as recited in claim 116, wherein said the purchase price for each of the credit accounts is calculated periodically.

120. The system as recited in claim 106, further comprising means for providing information associated with the purchased credit accounts to the user after receiving the payment.

121. The system as recited in claim 120, wherein said information associated with the purchased credit accounts includes a debtor name, a debtor address, an original creditor, a balance amount, a last payment date, a charge off date, a delinquency date, an open date, a home phone number, a work phone number, a social security phone number and co-debtor information.

121. The system as recited in claim 106, further comprising means for receiving from the user acknowledgment of and agreement to a purchase agreement, a user agreement and a privacy policy
